(19) United States
(12) Patent Application Publication
(10) Pub. No.: US 2015/0165376 A1
(43) Pub. Date: Jun. 18, 2015

(54) CATALYTIC DEVICE OF INTERNAL COMBUSTION ENGINE

(71) Applicant: Toyota Jidosha Kabushiki Kaisha, Toyota-shi Aichi-ken (JP)

(72) Inventors: Keisuke Nagasaka, Susono-shi Shizuoka-ken (JP); Hiroshi Tanaka, Susono-shi Shizuoka-ken (JP); Kazuki Tsurumi, Susono-shi Shizuoka-ken (JP)

(21) Appl. No.: 14/567,725

(22) Filed: Dec. 11, 2014

(30) Foreign Application Priority Data
Dec. 13, 2013 (JP) 2013-258603
Dec. 1, 2014 (JP) 2014-243539

(51) Int. Cl. B01D 53/94

(52) U.S. Cl. CPC B01D 53/94

(57) ABSTRACT

A catalytic device of an internal combustion engine includes: an electrical heating catalytic unit; a downstream side catalytic unit that is located on a downstream side of the electrical heating catalytic unit; an outer cylinder that houses the electrical heating catalytic unit and the downstream side catalytic unit; and a first insulating member that is provided on an inner face of the outer cylinder from at least a part housing the electrical heating catalytic unit to another part housing the downstream side catalytic unit, wherein: the downstream side catalytic unit is divided into an outer circumference portion and an inner portion that is surrounded by the outer circumference portion; and a thermal amount of exhaust gas flowing in the outer circumference portion is larger than a thermal amount of exhaust gas flowing in the inner portion.

### CROSS-REFERENCE TO RELATED APPLICATION

This application is based upon and claims the benefit of priority of the prior Japanese Patent Application No. 2013-258603, filed on Dec. 13, 2013, and the Japanese Patent Application No. 2014-243539, filed on Dec. 1, 2014, the entire contents of which are incorporated herein by reference.

### FIELD OF THE INVENTION

The present invention relates to a catalytic device of an internal combustion engine.

### BACKGROUND

There is known a catalytic device that has an electrical heating catalytic unit that can be heated by energization (see Japanese Patent Application Publication No. 2012-21488 hereinafter referred to as Document 1). Document 1 discloses an electrical heating catalytic device that has a downstream side catalytic unit on the downstream side of an electrical heating catalytic unit. In the catalytic device, a heater ring that can remove soot in exhaust gas deposited on a ring thereof is fixed in a pipe on the upstream side of the electrical heating catalytic unit. Japanese Patent Application Publications No. 8-238420, No. 11-148346 and No. 11-82000 disclose a cell density of a catalyst carrier. Japanese Patent Application Publication No. 2012-237280 discloses a purification device of exhaust gas that discharges moisture content inside of a housing portion of the carrier.

### SUMMARY OF THE INVENTION

It is an object of the present invention to provide a catalytic device of an internal combustion engine that has a downstream side catalytic unit on a downstream side of an electrical heating catalytic unit and is capable of improving insulating property on the downstream side of the electrical heating catalytic unit.

According to an aspect of the present invention, there is provided a catalytic device of an internal combustion engine including: an electrical heating catalytic unit; a downstream side catalytic unit that is located on a downstream side of the electrical heating catalytic unit; an outer cylinder that houses the electrical heating catalytic unit and the downstream side catalytic unit; and a first insulating member that is provided on an inner face of the outer cylinder from at least a part housing the electrical heating catalytic unit to another part housing the downstream side catalytic unit, wherein: the downstream side catalytic unit is divided into an outer circumference portion and an inner portion that is surrounded by the outer circumference portion; and a thermal amount of exhaust gas flowing in the outer circumference portion is larger than a thermal amount of exhaust gas flowing in the inner portion.

### BRIEF DESCRIPTION OF THE DRAWINGS

FIG. 1 illustrates an outline structure of a catalytic device of an internal combustion engine;

FIG. 2 illustrates a main part of a first concrete example of a catalytic device of an internal combustion engine;

FIG. 3 illustrates a main part of a second concrete example of a catalytic device of an internal combustion engine;

FIG. 4 illustrates a main part of a third concrete example of a catalytic device of an internal combustion engine;

FIG. 5 illustrates a main part of a fourth concrete example of a catalytic device of an internal combustion engine;

FIG. 6 illustrates a main part of a fifth concrete example of a catalytic device of an internal combustion engine;

FIG. 7 illustrates a main part of a sixth concrete example of a catalytic device of an internal combustion engine;

FIG. 8 illustrates a main part of a seventh concrete example of a catalytic device of an internal combustion engine;

FIG. 9 illustrates a main part of an eighth concrete example of a catalytic device of an internal combustion engine; and

FIG. 10 illustrates an example of a modified example of a catalytic device of an internal combustion engine.

### DETAILED DESCRIPTION

A catalytic device of an internal combustion engine may have a structure in which a downstream side catalytic unit is provided on the downstream side of an electrical heating catalytic unit. In this case, when a temperature of a metal catalyst is lower than an activating temperature at a cold starting of an engine or the like, it is possible to purify exhaust gas as follows. That is, it is possible to purify the exhaust gas early with use of the electrical heating catalytic unit by heating the electrical heating catalytic unit by energization. After that, it is possible to purify the exhaust gas with use of the downstream side catalytic unit when the temperature of the metal catalyst of the downstream side catalytic unit is higher than the activating temperature.

However, the exhaust gas includes moisture content or carbon that are conductive substances. Therefore, in the above-mentioned catalytic device of the internal combustion engine, a current leak path conducted to an uninsulated portion from the electrical heating catalytic unit may occur because of condensed water or the carbon. As a result, during an energizing to the electrical heating catalytic unit, a short circuit may occur.

The heater ring disclosed in Document 1 is provided in the pipe on the upstream side of the electrical heating catalytic unit. Therefore, the heater ring disclosed in Document 1 may be capable of removing soot by burning or dew condensation by heating on the upstream side of the electrical heating catalytic unit. However, this case may be disadvantageous in cost. And, it is necessary to improve the insulating property not only on the upstream side but also on the downstream side of the electrical heating catalytic unit.

A description will be given of embodiments of the present invention with use of drawings.

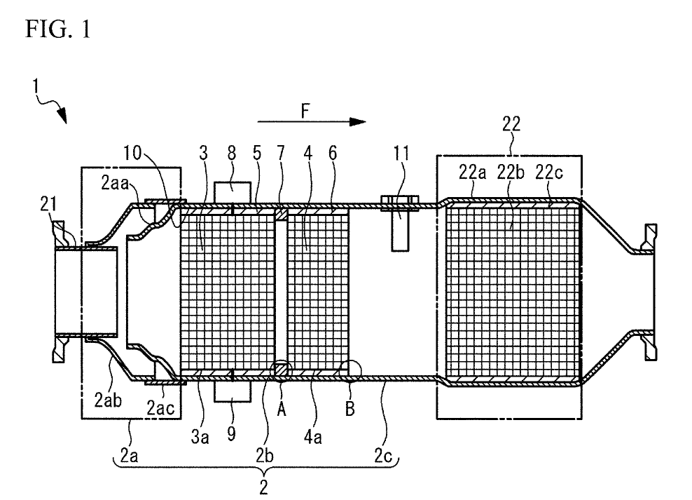

FIG. 1 illustrates an outline structure of a catalytic device 1 of an internal combustion engine (hereinafter referred to as a catalytic device). An arrow F indicates a circulation direction of exhaust gas. The catalytic device 1 has an outer cylinder 2, a catalytic unit 3, a catalytic unit 4, a mat 5, a mat 6, an insulating member 7, electrodes 8 and 9, and an insulating member 10. The catalytic device 1 purifies the exhaust gas of the internal combustion engine. The internal combustion engine is mounted on a vehicle.

The outer cylinder 2 is a first outer cylinder and houses the catalytic unit 3 and the catalytic unit 4. The outer cylinder 2 has conductivity. The insulating member 10 is provided on a portion of the outer cylinder 2 that is in touch with the exhaust gas. The portion may be at least an internal face of a portion 2b of the outer cylinder 2. The portion 2b has a structure from a portion of the outer cylinder 2 that houses the catalytic unit 3 to a portion of the outer cylinder 2 that houses the catalytic unit 4. The insulating member 10 is a first insulating member and secures insulating property of the catalytic unit 3 and the catalytic unit 4 from a vehicle body to which a voltage leaks. The insulating member 10 is, for example, a glass coat. The insulating member 10 may be formed by coating.

The outer cylinder 2 can be divided into a portion 2a, the portion 2b and a portion 2c in order from an upstream side. That is, the portion 2a is located on an upstream side of the portion 2b. Here, the portion 2a can be further divided into a portion 2aa, a portion 2ab and a portion 2ac. A diameter of the portion 2aa gradually decreases from the portion 2b to the upstream side. The portion of which diameter is reduced has a cross section of a waveform. Thus, a creeping face is extended. The portion 2ab is located on the upstream side of the portion 2aa. And, the portion 2ab has a shape along the portion 2aa. An edge of the downstream side of the portion 2aa has the same outer diameter as that of an edge of the downstream side of the portion 2ab. The portion 2ac is a ring shape portion and connects the edge of the downstream side of the portion 2aa with the edge of the downstream side of the portion 2ac. The portion 2a having the structure has a shape in which the portion 2aa projects toward the upstream side. And, the portion 2ab and the portion 2ac surround a circumference of the portion 2a. In this manner, the portion 2a located at the edge of the upstream side of the outer cylinder 2 has a labyrinth structure in which the portion 2a is doubled and a circulation path is complicated.

The portion 2b houses the catalytic unit 3 and the catalytic unit 4. The catalytic unit 3 is supported in the portion 2b via the mat 5 that acts as a first mat. The catalytic unit 4 is supported in the portion 2b via the mat 6 that acts as a second mat. The portion 2b has a constant inner diameter. The portion 2b has the electrodes 8 and 9 that are respectively positive and negative. The electrodes 8 and 9 are insulated from the outer cylinder 2, penetrate the outer cylinder 2 and the mat 5, and is in touch with an outer circumference face of the catalytic unit 3.

The portion 2c is located on the downstream side of the portion 2b. The portion 2c extends from the portion 2b to the downstream side. The portion 2c has a constant inner diameter. The portion 2c has a sensor 11. The sensor 11 is, for example, a sensor of exhaust gas temperature or a sensor of air-fuel ratio and projects into the portion 2c.

The outer cylinder 2 has at least the portion 2b of the portion 2a, the portion 2b and the portion 2c. Therefore, the outer cylinder 2 may be the portion 2b, or the portion 2a and the portion 2b. The portion 2aa of the portion 2a and the portion 2b may be integrally structured or may be individually structured. The portion 2b and the portion 2c are similar to the portion 2a.

As mentioned above, the outer cylinder 2 houses the catalytic unit 3 and the catalytic unit 4. The catalytic unit 3 is an electrical heating catalytic unit that is heated by heat generation caused by energization. The catalytic unit 3 has a substrate and a metal catalyst. The substrate supports the metal catalyst. In concrete, the substrate is energization-heat-generation substrate made of a material generating heat by energization and circulates the exhaust gas. A cell structure made of non-metal member or a metal member that can generate heat by energization can be applied to the substrate. The cell structure has a cell acting as a gap and can circulate the exhaust gas by the cell. The cell structure may have a structure in which the structure of the cell is regular or may have a structure in which the structure of the cell is irregular. For example, SiC (silicon carbide) may be applied to the substrate. The metal catalyst is supported on a surface of the substrate. An arbitrary metal including a noble metal or metal compound can be applied to the metal catalyst.

The catalytic unit 4 is a downstream side catalytic unit that is located on the downstream side of the catalytic unit 3. The catalytic unit 4 has a substrate supporting a metal catalyst and has the metal catalyst. A cell structure that has a cell and is capable of circulating the exhaust gas by the cell can be applied to the substrate of the catalytic unit 4. A ternary catalyst having cordierite acting as a substrate can be applied to the catalytic unit 4.

The mat 5 is a supporting member that supports the catalytic unit 3. The mat 6 is a supporting member that supports the catalytic unit 4. The mat 5 and the mat 6 have insulating property. A whole length of the mat 5 is the same as that of the catalytic unit 3. A whole length of the mat 6 is the same as that of the catalytic unit 4. A mat made of a ceramics fiber can be applied to the mat 5 and the mat 6. The mat made of the ceramics fiber is, for example, a mat made of alumina. The mat 5 may be divided so as to support both edges of the catalytic unit 3. The mat 6 may be divided so as to support both edges of the catalytic unit 4. In this case, a space formed between the divided mats enhances heat retaining property. As a result, vaporization of condensed water is promoted.

The insulating member 7 is a second insulating member and is provided between the catalytic unit 3 and the catalytic unit 4 in a circulation direction of the exhaust gas indicated by the arrow F. The insulating member 7 provided in this manner is also provided between the mat 5 and the mat 6. The insulating member 7 has a cylinder shape. The insulating member 7 is in touch with an inner face of the outer cylinder 2. For example, a mat made of a ceramics fiber can be applied to the insulating member 7.

An exhaust pipe 21 is connected to the catalytic device 1 from an upstream side. An under floor convertor (hereinafter referred to as UFC) 22 is connected to the catalytic device 1 from a downstream side. The UFC 22 has an outer cylinder 22a, a catalytic unit 22b and a mat 22c. The outer cylinder 22a is a second outer cylinder and houses the catalytic unit 22b. The outer cylinder 22a is connected to the outer cylinder 2 from a downstream side. The outer cylinder 22a may be integrally structured with the outer cylinder 2 and may be separated from the outer cylinder 2. The catalytic unit 22b may have the same structure as the catalytic unit 4. The mat 22c is a supporting member that supports the catalytic unit 22b in the outer cylinder 22a.

A catalyst other than the ternary catalyst may be used as the catalytic unit 4 or the catalytic unit 22b. A catalyst other than the catalytic unit 3 may be used as the catalytic unit 4 or the catalytic unit 22b. In concrete, a storage reduction type NOx catalyst, a selective reduction NOx catalyst, an oxidation catalyst or the like may be used as the catalytic unit 4 or the catalytic unit 22b in accordance with an object or a framework condition of a catalytic reaction (chemical reaction promoted by a metal catalyst) of the catalytic unit 3 and the catalytic unit 4 described later.

The exhaust gas includes moisture content or carbon that are conductive substances. Therefore, condensed water may be accumulated in the outer cylinder 2. And, the carbon may be deposited in the outer cylinder 2. The condensed water may be accumulated in the mat 6. The carbon may be deposited in a portion A or a portion B, for example. The portion A is a portion between the catalytic unit 3 and the catalytic unit 4 in a circulation direction of the exhaust gas indicated by the arrow F. The portion B is a portion just after the catalytic unit 4 in the circulation direction of the exhaust gas indicated by the arrow F.

The sensor 11 and the outer cylinder 22a act as a portion that is conducted to a vehicle body on the downstream side of the catalytic unit 3 and is not insulated. And, when the carbon deposited in the outer cylinder 2 and the condensed water accumulated in the outer cylinder 2 form a current leak path conducted to the sensor 11 and the outer cylinder 22a from the catalytic unit 3, a current is leaked to the vehicle body from the catalytic unit 3.

In view of the circumstances, in the catalytic device 1, the catalytic unit 3 and the catalytic unit 4 are structured as described in the following. As a result, an induction portion that induces the exhaust gas to an outer circumference portion 4a of the catalytic unit 4 is achieved. In concrete, the induction portion is achieved so as to include at least one of an outer circumference portion 3a of the catalytic unit 3 and the outer circumference portion 4a. The outer circumference portion 3a is a part including an outer circumference of the catalytic unit 3. The outer circumference portion 4a is a part including an outer circumference of the catalytic unit 4.

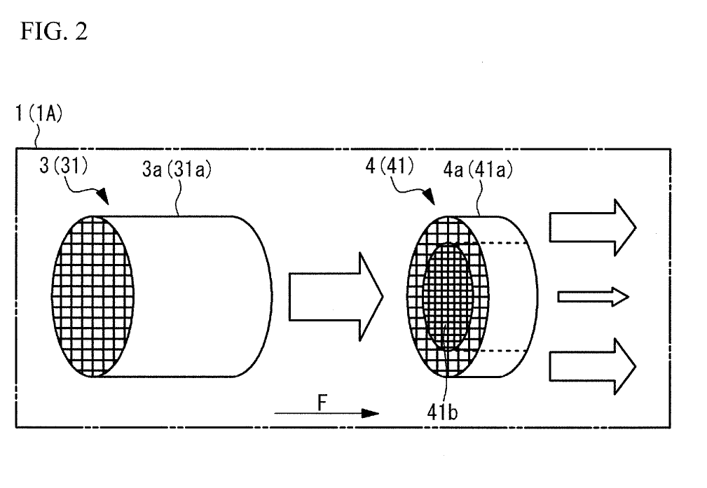

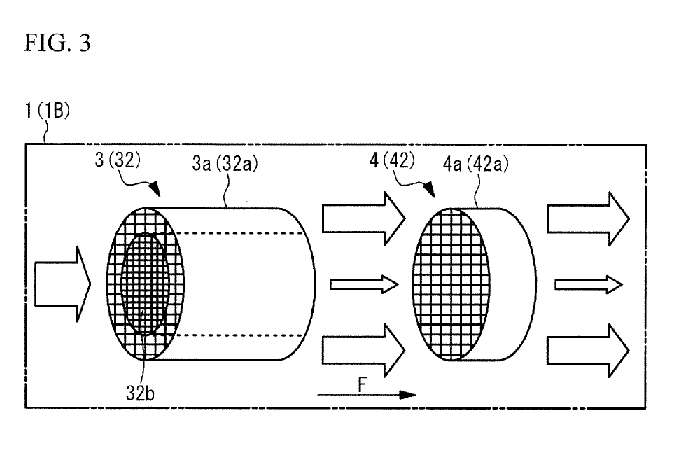

FIG. 2 illustrates a main part of a catalytic device 1A that is a first concrete example of the catalytic device 1. In FIG. 2, the circulation of the exhaust gas is indicated by outline arrows. In FIG. 3 to FIG. 9, the circulation of the exhaust gas is indicated by outline arrows. The catalytic device 1A is different from the catalytic device 1 in a point that a catalytic unit 31 and a catalytic unit 41 are provided instead of the catalytic unit 3 and the catalytic unit 4. The catalytic unit 31 is different from the catalytic unit 3 in a point that a cell is structured as follows. The catalytic unit 41 is different from the catalytic unit 4 in a point that a cell is structured as follows. In the following, a description will be given of the catalytic unit 41.

The catalytic unit 41 has an outer circumference portion 41a and a portion 41b. In concrete, the catalytic unit 41 is divided into the outer circumference portion 41a and the portion 41b surrounded by the outer circumference portion 41a. The outer circumference portion 41a is an example of the outer circumference portion 4a and includes an outer circumference of the catalytic unit 41. The portion 41b is inside of the outer circumference portion 4a. The outer circumference portion 41a has a cell density that is lower than that of the portion 41b. That is, the outer circumference portion 41a has a circulation resistance that is lower than that of the portion 41b. In the outer circumference portion 41a, the structure of the cell is regular and even. In the portion 41b, the structure of the cell is regular and even. The “even” includes a case where there is variety within a manufacturing error or a manufacturing tolerance.

The cell density of the catalytic unit 31 is the same as that of the outer circumference portion 41a. In the catalytic unit 31, the structure of the cell is regular and even. An outer circumference portion 31a of the catalytic unit 31 is an example of the outer circumference portion 3a and includes an outer circumference of the catalytic unit 31. In concrete, the outer circumference portion 31a may be a portion that does not overlap with the portion 41b viewed along the circulation direction of the exhaust gas indicated by the arrow F.

It is easy for the exhaust gas to circulate in the outer circumference portion 41a in the catalytic unit 41 because the cell of the outer circumference portion 41a is structured as mentioned above. The outer circumference portion 41a makes the circulation of the exhaust gas. Therefore, the exhaust gas is induced into the outer circumference portion 41a.

In the catalytic device 1A, when the exhaust gas is induced into the outer circumference portion 41a, an amount of exhaust gas circulating in the outer circumference portion 41a increases. As a result, an amount of the exhaust gas purified by the outer circumference portion 41a increases. Therefore, a catalytic reaction amount of the outer circumference portion 41a increases. And, a temperature of the exhaust gas flowing out from the outer circumference portion 41a gets higher. That is, in the catalytic unit 41, a thermal amount of the exhaust gas flowing in the inner portion 41b is larger than a thermal amount of the exhaust gas flowing in the outer circumference portion 41a. As a result, the carbon deposited in the portion B is easily oxidized. Therefore, the catalytic device 1A can prevent or suppress the formation of a current leak path conducted to the sensor 11 or the outer cylinder 22a from the catalytic unit 3. As a result, insulating property on the downstream side of the catalytic unit 3 can be improved.

When the catalytic reaction amount of the outer circumference portion 41a increases, the temperature of the mat 6 or the portion A gets higher. As a result, evaporation of the condensed water is promoted in the mat 6. And, it is difficult for the condensed water to accumulate in the mat 6. The carbon deposited in the portion A is easily oxidized. Therefore, the catalytic device 1A can improve the insulating property on the downstream side of the catalytic unit 3 by these effects.

The catalytic device 1A is an example in which an induction portion includes the outer circumference portion 4a of the outer circumference portions 3a and 4a. In the catalytic device 1A, in concrete, the induction portion is structured by the outer circumference portion 41a. In concrete, in the catalytic device 1A, the catalytic unit 4 of the catalytic units 3 and 4 performs the catalytic reaction, and thereby the exhaust gas may be purified.

FIG. 3 illustrates a main part of a catalytic device 1B that is a second concrete example of the catalytic device 1. The catalytic device 1B is different from the catalytic device 1 in a point that catalytic units 32 and 42 are provided instead of the catalytic units 3 and 4. The catalytic unit 32 is different from the catalytic unit 3 in a point that the cell is structured as follows. The catalytic unit 42 is different from the catalytic unit 4 in a point that the cell is structured as follows.

The catalytic unit 32 has an outer circumference portion 32a and a portion 32b. In concrete, the catalytic unit 32 is divided into the outer circumference portion 32a and the inner portion 32b that is surrounded by the outer circumference portion 32a. The outer circumference portion 32a is an example of the outer circumference portion 3a and includes an outer circumference of the catalytic unit 32. The portion 32b is inside of the outer circumference portion 32a. The cell density of the outer circumference portion 32a is lower than that of the portion 32b. That is, the circulation resistance of the outer circumference portion 32a is lower than that of the portion 32b. In the outer circumference portion 32a, the structure of the cell is regular an even. The cell structure in the portion 32b is also regular and even.

The cell density of the catalytic unit 42 is the same as that of the outer circumference portion 32a. In the catalytic unit 42, the cell structure is regular and even. An outer circumference portion 42a of the catalytic unit 42 is an example of the outer circumference portion 4a and includes an outer circumference of the catalytic unit 42. In concrete, the outer circumference portion 42a is a portion that does not overlap with the portion 32b viewed along the circulation direction of the exhaust gas indicated by the arrow F.

When the cell of the outer circumference portion 32a is structured as mentioned above, the exhaust gas easily circulates in the outer circumference portion 32a in the catalytic unit 32. And, the exhaust gas having circulated in the outer circumference portion 32a mainly flows into the outer circumference portion 42a in accordance with the flow of the exhaust gas. The outer circumference portion 32a induces the exhaust gas into the outer circumference portion 42a by circulating the exhaust gas.

In the catalytic device 1B, when the exhaust gas is induced into the outer circumference portion 42a, the amount of the exhaust gas circulating in the outer circumference portion 42a increases. That is, in the catalytic unit 42, the thermal amount of the exhaust gas flowing in the outer circumference portion 42a increases. Therefore, the catalytic device 1B can improve the insulating property on the downstream side of the catalytic unit 3, as well as the catalytic device 1A.

In the case of the catalytic device 1A, the catalytic unit 31 is provided instead of the catalytic unit 3. Thereby, the cell structure of the catalytic unit 3 is regular and even. However, for the exhaust gas, flowing into a portion that is inside of the outer circumference portion 3a is easier than flowing into the outer circumference portion 3a. Therefore, in this case, it is possible that the catalytic reaction amount of the outer circumference portion 3a is less than that of the portion that is inside of the outer circumference portion 3a. As a result, a temperature distribution may occur in a diameter direction. And, cracking of the substrate of the catalytic unit 3 caused by the thermal stress may easily occur.

In the case of the catalytic device 1B, the catalytic unit 32 is provided instead of the catalytic unit 3. Thereby, the amount of the exhaust gas circulating in the outer circumference portion 3a increases. And, it is possible to reduce a difference of the catalytic reaction amounts between the outer circumference portion 3a and the portion that is inside of the outer circumference portion 3a. Therefore, the catalytic device 1B can adjust the catalytic reaction amount of the catalytic unit 3. As a result, the cracking of the substrate of the catalytic unit 3 caused by the thermal stress can be prevented or suppressed.

In the catalytic device 1B, the induction portion has the outer circumference portion 3a of the outer circumference portion 3a and the outer circumference portion 4a. In the catalytic device 1B, in concrete, the induction portion is achieved by the outer circumference portion 32a. In concrete, the catalytic device 1B has a structure for purifying the exhaust gas in which at least the catalytic unit 4 of the catalytic unit 3 and the catalytic unit 4 performs a catalytic reaction that is exothermal reaction.

The catalytic device 1B may have a structure for purifying the exhaust gas in which at least the catalytic unit 3 of the catalytic unit 3 and the catalytic unit 4 performs a catalytic reaction that is an exothermal reaction. In this case, when the amount of the exhaust gas circulating in the outer circumference portion 3a and the amount of the exhaust gas purified by the outer circumference portion 3a increases, the thermal amount of the exhaust gas flowing out from the outer circumference portion 3a increases and the temperature of the exhaust gas gets higher. Therefore, the temperature of the exhaust gas flowing into the outer circumference portion 4a and the thermal amount of the exhaust gas circulating in the outer circumference portion 4a increase, and thereby the temperature of the exhaust gas gets higher. Further, the temperature of the exhaust gas flowing out from the outer circumference portion 4a gets higher. As a result, when the temperature of the mat 6 or the portion A in addition to the portion B gets higher, the insulating property on the downstream side of the catalytic unit 3 can be improved.

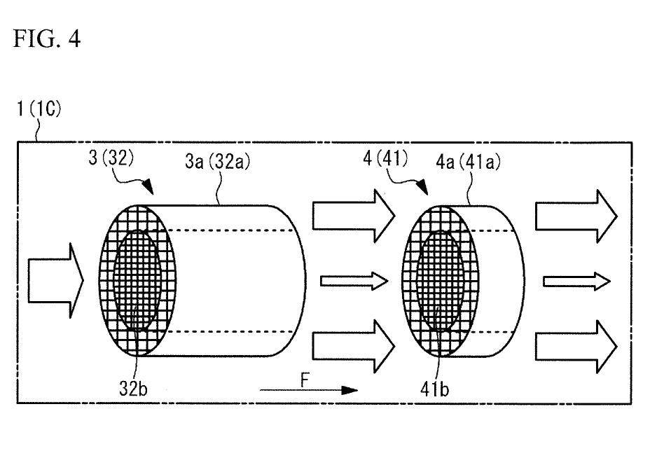

FIG. 4 illustrates a main part of a catalytic device 1C that is a third concrete example of the catalytic device 1. The catalytic device 1C is different from the catalytic device 1 in a point that the catalytic unit 32 and the catalytic unit 41 are provided instead of the catalytic unit 3 and the catalytic unit 4. The catalytic device 1C induces the exhaust gas to the outer circumference portion 4a by the outer circumference portion 3a and the outer circumference portion 4a. As a result, in comparison with the catalytic device 1A and the catalytic device 1B, more exhaust gas can be induced to the outer circumference portion 4a. Therefore, the catalytic reaction amount of the outer circumference portion 4a can be enlarged more than the catalytic device 1A and the catalytic device 1B. That is, in the catalytic unit 42, the thermal amount of the exhaust gas flowing in the outer circumference portion 4a is enlarged. Therefore, the insulating property on the downstream side of the catalytic unit 3 can be enhanced more than the catalytic device 1A and the catalytic device 1B.

In the catalytic device 1C, the induction portion includes the outer circumference portion 3a and the outer circumference portion 4a. In the catalytic device 1C, in concrete, the induction portion is achieved by the outer circumference portion 32a and the outer circumference portion 41a.

In concrete, the catalytic device 1C may have a structure for purifying the exhaust gas in which at least the catalytic unit 4 of the catalytic unit 3 and the catalytic unit 4 performs a catalytic reaction. The catalytic device 1C may have a structure for purifying the exhaust gas in which at least the catalytic unit 3 of the catalytic unit 3 and the catalytic unit 4 performs a catalytic reaction that is an exothermal reaction.

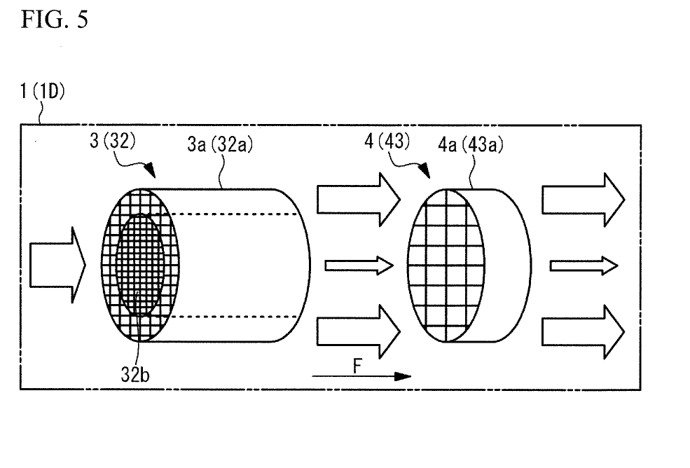

FIG. 5 illustrates a main part of a catalytic device 1D that is a fourth concrete example of the catalytic device 1. The catalytic device 1D is different from the catalytic device 1 in a point that the catalytic unit 32 and a catalytic unit 43 are provided instead of the catalytic unit 3 and the catalytic unit 4. The catalytic unit 32 is described above. The catalytic unit 43 is different from the catalytic unit 4 in a point that the cell is structured as follows.

The cell density of the catalytic unit 43 is lower than that of the outer circumference portion 32a. In the catalytic unit 43, the structure of the cell is regular and even. Therefore, a cell density of an outer circumference portion 43a of the catalytic unit 43 is lower than that of the outer circumference portion 32a. The outer circumference portion 43a is an example of the outer circumference portion 4a and includes an outer circumference of the catalytic unit 43. In concrete, the outer circumference portion 43a may be a portion that does not overlap with the portion 32b viewed along the circulation direction of the exhaust gas indicated by the arrow F.

In the catalytic device 1D, the cell of the outer circumference portion 43a is structured as mentioned above. Therefore, the circulation condition of the exhaust gas having circulated in the outer circumference portion 32a is more difficult to disturb than the catalytic device 1B. In other words, in the catalytic device 1D, it is easier for the exhaust gas having circulated in the outer circumference portion 32a to flow into the outer circumference portion 4a than the catalytic device 1B.

The catalytic device 1D structured in this manner can induce more exhaust air to the outer circumference portion 4a than the catalytic device 1B. Therefore, the catalytic reaction amount of the outer circumference portion 4a can be enlarged than the catalytic device 1B. Therefore, the insulating property on the downstream side of the catalytic unit 3 can be more enhanced than the catalytic device 1B.

The catalytic device 1D is an example in which the induction portion includes the outer circumference portion 3a of the outer circumference portion 3a and the outer circumference portion 4a. In the catalytic device 1D, in concrete, the induction portion is achieved by the outer circumference portion 32a, In the catalytic device 1D, the induction portion may be achieved by the outer circumference portion 32a and the outer circumference portion 43a.

In concrete, the catalytic device 1D may have a structure for purifying the exhaust gas in which at least the catalytic unit 4 of the catalytic unit 3 and the catalytic unit 4 performs a catalytic reaction that is an exothermal reaction. The catalytic device 1D may have a structure for purifying the exhaust gas in which at least the catalytic unit 3 of the catalytic unit 3 and the catalytic unit 4 performs a catalytic reaction that is an exothermal reaction.

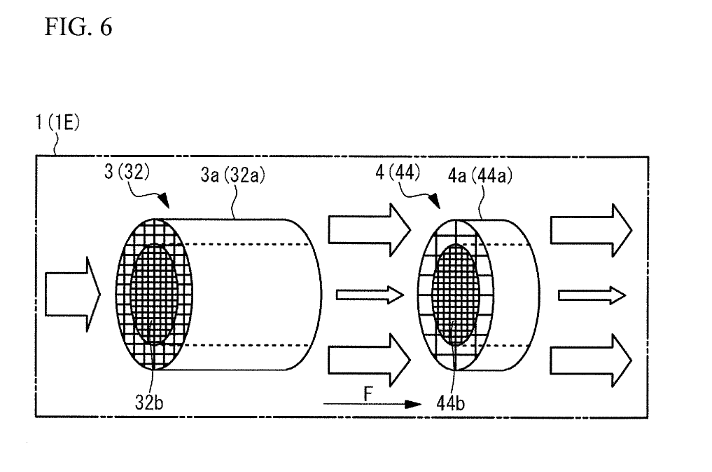

FIG. 6 illustrates a main part of a catalytic device 1E that is a fifth concrete example of the catalytic device 1. The catalytic device 1E is different from the catalytic device 1 in a point that the catalytic unit 32 and a catalytic unit 44 are provided as the catalytic unit 3 and the catalytic unit 4. The catalytic unit 32 is mentioned above. The catalytic unit 44 is different from the catalytic unit 4 in a point that the cell is structured as follows.

The catalytic unit 44 has an outer circumference portion 44a and a portion 44b. The outer circumference portion 44a is an example of the outer circumference portion 4a and includes an outer circumference of the catalytic unit 44. The portion 44b is inside of the outer circumference portion 44a. The cell density of the outer circumference portion 44a is a lower than that of the portion 44b. The cell density of the outer circumference portion 44a is lower than that of the outer circumference portion 32a. In the outer circumference portion 44a, the structure of the cell is regular and even. In the portion 44b, the structure of the cell is also regular and even.

In the catalytic device 1E, the exhaust gas flowing in the outer circumference portion 32a flows into the outer circumference portion 4a more easily than the catalytic device 1C and the catalytic device 1D, because the cell of the outer circumference portion 44a is structured as mentioned above.

The catalytic device 1E can induce more exhaust gas to the outer circumference portion 4a than the catalytic device 1C and the catalytic device 1D. Therefore, it is possible to increase the catalytic reaction amount of the outer circumference portion 4a, compared to the catalytic device 1C and the catalytic device 1D. It is therefore possible to enhance the insulating property on the downstream side of the catalytic unit 3, compared to the catalytic device 1C and the catalytic device 1D.

The catalytic device 1E is an example in which the induction portion has the outer circumference portion 3a and the outer circumference portion 4a. In the catalytic device 1E, in concrete, the induction portion is achieved by the outer circumference portion 32a and the outer circumference portion 44a.

The catalytic device 1E may have a structure for purifying the exhaust gas in which at least the catalytic unit 4 of the catalytic unit 3 and the catalytic unit 4 performs the catalytic reaction that is an exothermal reaction. The catalytic device 1E may have a structure for purifying the exhaust gas in which the at least the catalytic unit 3 of the catalytic unit 3 and the catalytic unit 4 performs the catalytic reaction that is an exothermal reaction.

In order to improve the insulating property on the downstream side of the catalytic unit 3 in the catalytic device 1, the catalytic unit 3 and the catalytic unit 4 may be structured as follows. In the catalytic device 1, the catalytic unit 3 and the catalytic unit 4 are structured as follows. Thereby, the catalytic reaction amount of at least one of the outer circumference portion 3a and the outer circumference portion 4a is more than that of a portion inside of the outer circumference portion with respect to an identical flow amount of the exhaust gas.

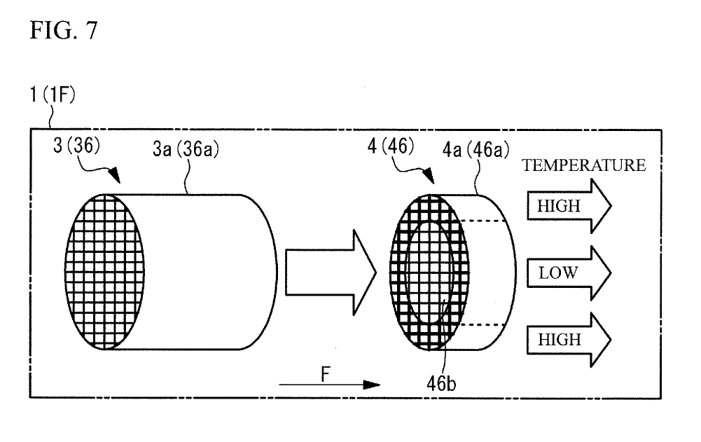

FIG. 7 illustrates a main part of a catalytic device 1F that is a sixth concrete example of the catalytic device 1. The catalytic device 1F is different from the catalytic device 1 in a point that a catalytic unit 36 and a catalytic unit 46 are provided as the catalytic unit 3 and the catalytic unit 4. The catalytic unit 36 is different from the catalytic unit 3 in a point that a supported amount of a metal catalyst of the catalytic unit 36 is as follows. The catalytic unit 46 is different from the catalytic unit 4 in a point that a supported amount of a metal catalyst of the catalytic unit 46 is as follows. First, a description will be given of the catalytic unit 46.

The catalytic unit 46 has an outer circumference portion 46a and a portion 46b. In concrete, the catalytic unit 46 is divided into the outer circumference portion 46a and the portion 46b that is an inside portion surrounded by the outer circumference portion 46a. The outer circumference portion 46a is an example of the outer circumference portion 4a and includes an outer circumference of the catalytic unit 46. The portion 46b is inside of the outer circumference portion 46a. An amount of the supported metal catalyst of the outer circumference portion 46a is larger than that of the portion 46b. Therefore, the catalytic reaction amount of the outer circumference portion 46a is more than the portion 46b with respect to an identical flow amount of the exhaust gas. As a result, the thermal amount of the exhaust gas flowing in the portion 46b is more than that of the exhaust gas flowing in the outer circumference portion 46a. The outer circumference portion 46a is structured so that the metal catalyst is evenly supported. The portion 46b is structured so that the metal catalytic is evenly supported.

An outer circumference portion 36a of the catalytic unit 36 is an example of the outer circumference portion 3a and includes an outer circumference of the catalytic unit 36. In concrete, the outer circumference portion 36a may be a portion that does not overlap with the portion 46b viewed along the circulation direction of the exhaust gas indicated by the arrow F. The catalytic unit 36 is structured so that the metal catalyst is supported evenly. Therefore, the outer circumference portion 36a is structured so that the metal catalyst is supported evenly.

In the catalytic device 1F, the catalytic reaction amount of the outer circumference portion 46a increases. Thereby, the thermal amount of the exhaust gas flowing out from the outer circumference portion 46a increases and the temperature gets higher. The catalytic device 1F can improve the insulating property on the downstream side of the catalytic unit 3 as well as the catalytic device 1A.

The catalytic device 1F is an example in which a catalytic reaction amount of the outer circumference portion 4a of the outer circumference portion 3a and the outer circumference portion 4a is more than that of a portion inside of the outer circumference portion 4a with respect to an identical flow amount of the exhaust gas. In concrete, the catalytic device 1F has a structure for purifying the exhaust gas in which at least the catalytic unit 4 of the catalytic unit 3 and the catalytic unit 4 performs the catalytic reaction that is an exothermal reaction.

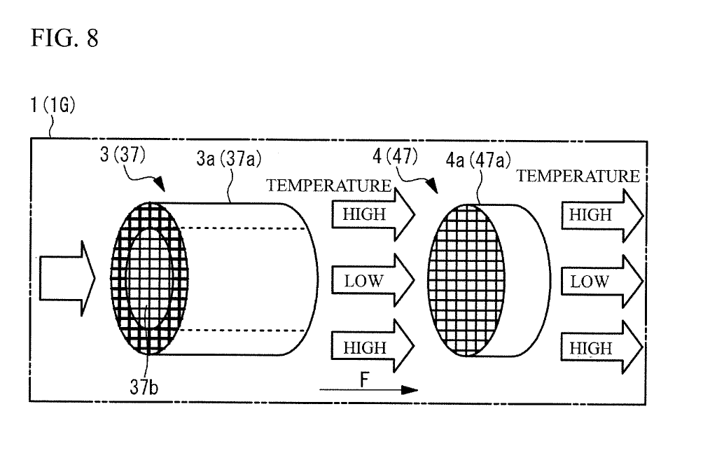

FIG. 8 illustrates a main part of a catalytic device 1G that is a seventh concrete example of the catalytic device 1. The catalytic device 1G is different from the catalytic device 1 in a point that a catalytic unit 37 and a catalytic unit 47 are provided as the catalytic unit 3 and the catalytic unit 4. The catalytic unit 37 is different from the catalytic unit 3 in a point that a supported amount of the metal catalyst is structured as follows. The catalytic unit 47 is different from the catalytic unit 4 in a point that a supported amount of the metal catalyst is structured as follows.

The catalytic unit 37 has an outer circumference portion 37a and a portion 37b. In concrete, the catalytic unit 37 is divided into the outer circumference portion 37a and the portion 37b that is an inner portion surrounded by the outer circumference portion 37a. The outer circumference portion 37a is an example of the outer circumference portion 3a and includes an outer circumference of the catalytic unit 37. The portion 37b is inside of the outer circumference portion 37a. An amount of supported metal catalyst of the outer circumference portion 37a is more than that of the portion 37b. Therefore, a catalytic reaction amount of the outer circumference portion 37a is more than that of the portion 37b with respect to an identical flow amount of the exhaust gas. The outer circumference portion 37a is structured so that the metal catalyst is supported evenly. The portion 37b is also structured so that the metal catalyst is supported evenly.

An outer circumference portion 47a of the catalytic unit 47 is an example of the outer circumference portion 4a and includes an outer circumference of the catalytic unit 47. In concrete, the outer circumference portion 47a may be a portion that does not overlap with the portion 37b viewed along the circulation direction of the exhaust gas indicated by the arrow F. The catalytic unit 47 is structured so that the metal catalyst is supported evenly. Therefore, the outer circumference portion 47a is structured so that the metal catalyst is supported evenly.

In the catalytic device 1G, the catalytic reaction amount of the outer circumference portion 37a is increased. Therefore, the temperature of the exhaust gas having circulated in the outer circumference portion 37a gets higher. The exhaust gas having circulated in the outer circumference portion 37a mainly flows into the outer circumference portion 47a along the flow of the exhaust gas. Therefore, in the catalytic device 1G, the thermal amount of the exhaust gas flowing into the outer circumference portion 47a is large. And, the temperature of the exhaust gas flowing into the outer circumference portion 47a gets higher. And, the temperature of the exhaust gas circulating in the outer circumference portion 47a and the temperature of the exhaust gas flowing out from the outer circumference portion 47a get higher. As a result, the temperature of the mat 6 and the portion A gets higher as well as the temperature of the portion B. Therefore, the insulating property on the downstream side of the catalytic unit 3 can be improved.

In the case of the catalytic device 1F, an amount of the supported metal catalyst of the catalytic unit 3 is even because the catalytic device 1F has the catalytic unit 36 as the catalytic unit 3. However, it is easier for the exhaust gas to flow into inside of the outer circumference portion 3a than into the outer circumference portion 3a, in view of the location. Therefore, in this case, the catalytic reaction amount of the outer circumference portion 3a may be smaller than the catalytic reaction amount of the portion that is inside of the outer circumference portion 3a. As a result, a temperature distribution may occur in the diameter direction. And, cracking of the substrate of the catalytic unit 3 caused by the thermal stress may tend to occur.

In the case of the catalytic device 1G, a difference between the catalytic reaction amounts of the outer circumference portion 3a and the portion that inside of the outer circumference portion 3a can be reduced because the catalytic device 1G has the catalytic unit 37 as the catalytic unit 3. Therefore, the catalytic device 1G can adjust the catalytic reaction amount of the catalytic unit 3. It is therefore possible to prevent or suppress the cracking of the substrate of the catalytic unit 3 caused by the thermal stress.

The catalytic device 1G is an example in which the catalytic reaction amount of the outer circumference portion 3a of the outer circumference portion 3a and the outer circumference portion 4a is larger than that of the portion that is inside of the outer circumference portion 3a with respect to an identical flow amount of the exhaust gas. In concrete, the catalytic device 1G may have a structure for purifying the exhaust gas in which the catalytic unit 3 of the catalytic unit 3 and the catalytic unit 4 performs the catalytic reaction that is an exothermal reaction.

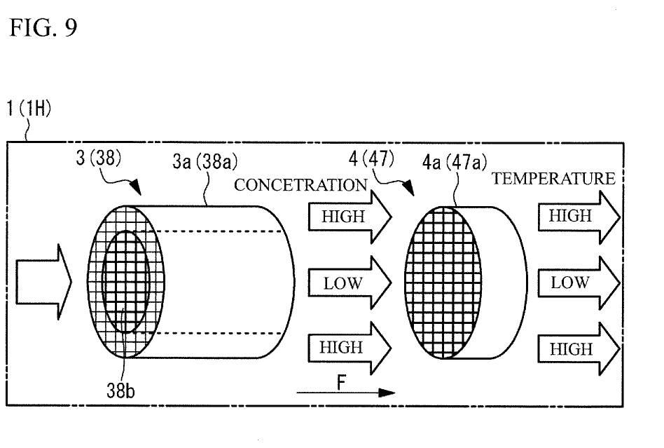

FIG. 9 illustrates a main part of a catalytic device 1H that is an eighth concrete example of the catalytic device 1. The catalytic device 1H is different from the catalytic device 1 in a point that a catalytic unit 38 and the catalytic unit 47 are provided as the catalytic unit 3 and the catalytic unit 4. The catalytic unit 38 is different from the catalytic unit 3 in a point that an amount of the supported metal catalyst is as follows. The catalytic unit 47 has the structure mentioned above.

The catalytic unit 38 has an outer circumference portion 38a and a portion 38b. In concrete, the catalytic unit 38 is divided into the outer circumference portion 38a and the portion 38b that is an inner portion surrounded by the outer circumference portion 38a. The outer circumference portion 38a is an example of the outer circumference portion 3a and includes an outer circumference of the catalytic unit 38. The portion 38b is inside of the outer circumference portion 38a. The amount of the supported metal catalyst of the outer circumference portion 38a is smaller than that of the portion 38b. Therefore, the catalytic reaction amount of the outer circumference portion 38a is smaller than that of the portion 38b with respect to an identical flow amount of the exhaust gas. The outer circumference portion 38a has a structure in which the metal catalyst is supported evenly. The portion 38b also has a structure in which the metal catalyst is supported evenly. In the catalytic device 1H, the outer circumference portion 47a may be a portion that does not overlap with the portion 38b viewed along the circulation direction of the exhaust gas indicated by the arrow F.

It is difficult for the outer circumference portion 38a to purify the exhaust gas because the amount of the supported metal catalyst is small. Therefore, in the exhaust gas flowing out from the outer circumference portion 38a, a concentration of unpurified exhaust gas gets higher. The exhaust gas flowing out from the outer circumference portion 38a mainly flows into the outer circumference portion 47a along the flowing direction of the exhaust gas. The exhaust gas purified by the outer circumference portion 38a and the exhaust gas purified by the outer circumference portion 47a have the same exhaust content. The exhaust gas content is, in concrete, unpurified component. An amount of purified exhaust gas of the outer circumference portion 47a increases because the concentration of the unpurified exhaust gas gets higher. As a result, in the outer circumference portion 47a, the catalytic reaction amount increases. The thermal amount caused by the reaction increases. And, the temperature of the exhaust gas flowing out from the outer circumference portion 47a gets higher. Therefore, in the catalytic device 1H, the insulating property on the downstream side of the catalytic unit 3 can be improved as well as the catalytic device 1A. In the catalytic device 1H, the amount of the supported metal catalyst can be reduced. Therefore, the catalytic device 1H has an advantage in a point of cost.

The catalytic device 1H is an example in which the catalytic reaction amount of the outer circumference portion 3a is smaller than that of the portion that is inside of the outer circumference portion 3a with respect to an identical flow amount of the exhaust gas. In concrete, the catalytic device 1G may have a structure for purifying the exhaust gas in which at least the catalytic unit 4 of the catalytic unit 3 and the catalytic unit 4 performs the catalytic reaction that is exothermal reaction.

When the amount of the supported metal catalyst is large, it is preferable that the catalytic device 1 has the structure of the catalytic device 1F or the catalytic device 1G from a viewpoint of necessary amount of the supported metal catalyst and obtained function and effect. However, the catalytic device 1 may have the catalytic unit 37 as the catalytic unit 3, and may have the catalytic unit 46 as the catalytic unit 4. That is, the catalytic device 1 may have a structure in which the catalytic reaction amount of both of the outer circumference portion 3a and the outer circumference portion 4a is larger than that of the portions that are inside of the outer circumference portion 3a and the outer circumference portion 4a with respect to an identical flow amount of the exhaust gas.

The catalytic device 1 may have a structure in which the structure of the cell of the catalytic unit 3 and the catalytic unit 4 of any of the catalytic devices 1A, 1B, 1C, 1D and 1E is applied to the catalytic unit 3 and the catalytic unit 4 of the catalytic devices 1F, 1G and 1H. The case is preferable in a point that the function and effect based on the structure of the cell and the structure of supported amount of the metal catalyst are achieved.

The above-mentioned examples of the catalytic device 1 are common in a point that increasing of the catalytic reaction amount increases the temperature of the exhaust gas flowing out from the outer circumference portion 4a, and thereby the insulating property on the downstream side of the catalytic unit 3 can be improved.

The catalytic device 1 has the following structure.

The catalytic device 1 has the outer cylinder 2 housing the catalytic unit 3 and the catalytic unit 4, and the insulating member 10 that is provided on at least the inner face of the portion 2b of the outer cylinder 2. The catalytic device 1 with the structure can improve the insulating property on the downstream side of the catalytic unit 3.

The catalytic device 1 has the insulating member 7 provided between the catalytic unit 3 and the catalytic unit 4. The insulating member 7 can suppress the formation of the current leak path conducted to the sensor 11 or the outer cylinder 22a from the catalytic unit 3 when it is difficult for the carbon to deposit on the portion A. The catalytic device 1 with the structure can improve the insulating property just after the catalytic unit 3.

The catalytic device 1 has a structure in which the portion 2a of the outer cylinder 2 has a labyrinth structure. It is difficult for the carbon to deposit on the portion 2a because the portion 2a has the labyrinth structure. A creeping distance from the catalytic unit 3 to the exhaust pipe 21 is secured. The exhaust pipe 21 acts as a portion that is not insulated from the vehicle body on the upstream side of the catalytic unit 3. Therefore, the catalytic device 1 with the structure can improve the insulating property on the upstream side of the catalytic unit 3 with the structure having an advantage in cost, compared to the case where a heater ring is provided.

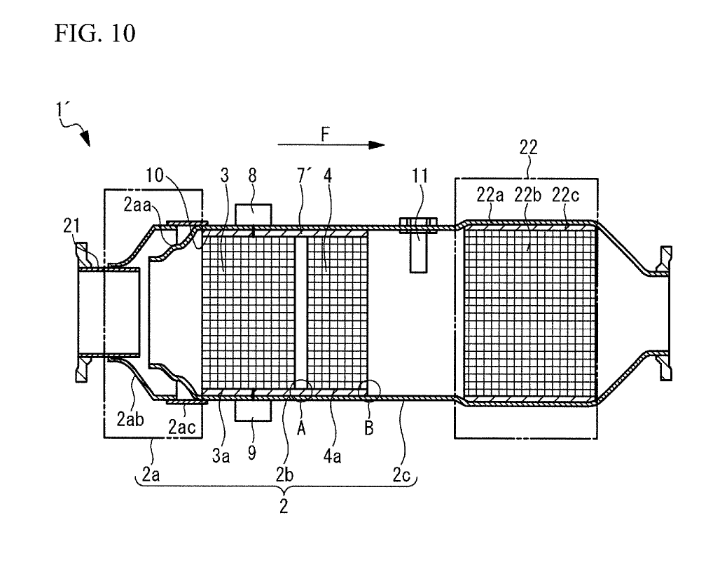

The insulating member 7 may be integrally structured with at least one of the mat 5 and the mat 6. FIG. 10 illustrates a catalytic device 1′ that is an example of a modified embodiment of the catalytic device 1. The catalytic device 1′ has an insulating member 7′ instead of the mat 5, the mat 6 and the insulating member 7. The insulating member 7′ supports the catalytic unit 3 and the catalytic unit 4. The insulating member 7′ is an insulating member corresponding to the insulating member 7 that is integrally structured with the mat 5 and the mat 6. A part of the insulating member 7′ acts as an insulating member provided between the catalytic unit 3 and the catalytic unit 4 in the circulation direction of the exhaust gas indicated by the arrow F.

The insulating member 7′ can suppress the formation of the current leak path conducted to the sensor 11 and the outer cylinder 22a from the catalytic unit 3 when it is difficult for the carbon to deposit on the portion A. The catalytic device 1′ with the structure can improve the insulating property just after the catalytic unit 3 as well as the catalytic device 1.

Although some embodiments of the present invention have been described in detail, the present invention is not limited to the specific embodiments but may be varied or changed within the scope of the present invention as claimed.

For example, in an electrical heating catalytic unit or a downstream side catalytic unit, a structure of a cell of an outer circumference portion, a portion inside of the outer circumference portion and a whole of the catalytic unit may be irregular or uneven. In the present invention, a case where a cell density is low includes a case where the structure of the cell has relatively many clearances and irregular. In the electrical heating catalytic unit or the downstream side catalytic unit, the metal catalyst of the outer circumference portion, the portion inside of the outer circumference portion and the whole of the catalytic unit may be supported unevenly.

What is claimed is:

1. A catalytic device of an internal combustion engine comprising:
an electrical heating catalytic unit;
a downstream side catalytic unit that is located on a downstream side of the electrical heating catalytic unit;
an outer cylinder that houses the electrical heating catalytic unit and the downstream side catalytic unit; and
a first insulating member that is provided on an inner face of the outer cylinder from at least a part housing the electrical heating catalytic unit to another part housing the downstream side catalytic unit,
wherein:
the downstream side catalytic unit is divided into an outer circumference portion and an inner portion that is surrounded by the outer circumference portion; and
a thermal amount of exhaust gas flowing in the outer circumference portion is larger than a thermal amount of exhaust gas flowing in the inner portion.

2. The catalytic device as claimed in claim 1, wherein:
at least one of the electrical heating catalytic unit and the downstream side catalytic unit is divided into an outer circumference portion and an inner portion that is surrounded by the outer circumference portion; and
a circulation resistance of exhaust gas of the outer circumference portion is smaller than a circulation resistance of exhaust gas of the inner portion.

3. The catalytic device as claimed in claim 2, wherein:
at least one of the electrical heating catalytic unit and the downstream side catalytic unit has a cell structure having a plurality of cells acting as a small space and is divided into an outer circumference portion and an inner portion surrounded by the outer circumference portion; and
a cell density of the outer circumference portion is lower than a cell density of the inner portion.

4. The catalytic device as claimed in claim 2, wherein:
the electrical heating catalytic unit and the downstream side catalytic unit have a cell structure having a plurality of cells acting as a small space; and
a cell density of the outer circumference portion of the downstream side catalytic unit is lower than a cell density of the outer circumference portion of the electrical heating catalytic unit.

5. The catalytic device as claimed in claim 1, wherein:
at least one of the electrical heating catalytic unit and the downstream side catalytic unit is divided into an outer circumference portion and an inner portion surrounded by the outer circumference portion; and
a catalytic reaction amount of the outer circumference portion is larger than a catalytic reaction amount of the inner portion with respect to an identical flow amount of exhaust gas.

6. The catalytic device as claimed in claim 1, wherein:
the electrical heating catalytic unit and the downstream side catalytic unit are divided into an outer circumference portion and an inner portion surrounded by the outer circumference portion;
a catalytic reaction amount of the outer circumference portion of the electrical heating catalytic unit is smaller than a catalytic reaction amount of the inner portion of the electrical heating catalytic unit with respect to an identical flow amount of exhaust gas; and
exhaust gas purified by the outer circumference portion of the electrical heating catalytic unit and exhaust gas purified by the outer circumference portion of the downstream side catalytic unit include an identical exhaust gas content.

7. The catalytic device as claimed in claim 1 further comprising a second insulating member that is provided between the electrical heating catalytic unit and the downstream side catalytic unit.
